(19) United States
(12) Patent Application Publication
(10) Pub. No.: US 2012/0292401 A1
(43) Pub. Date: Nov. 22, 2012

(54) Power Delivery to Diaphragms

(75) Inventors: Raghavendran Mahalingam, Austin, TX (US); Markus Schwickert, Austin, TX (US); Elise Hime, Austin, TX (US); Samuel N. Heffington, Austin, TX (US); Robert T. Reichenbach, Pflugerville, TX (US); James Kelly, Austin, TX (US); John Stanley Booth, Austin, TX (US); Randall P. Williams, Austin, TX (US); Matthew B. Ernst, Union Grove, WI (US)

(73) Assignee: Nuventix Inc.

(21) Appl. No.: 13/473,535

(22) Filed: May 16, 2012

Related U.S. Application Data
(60) Provisional application No. 61/487,277, filed on May 18, 2011.

(51) Int. Cl. B05B 1/08

(52) U.S. Cl. 239/102.1

(57) ABSTRACT

A method is provided for forming tinsel on a synthetic jet actuator. The method comprises (a) providing a synthetic jet actuator assembly (201) comprising a bobbin (203), a voice coil (213), driver electronics (215), and a surround (205); and (b) printing polymer thick film (PTF) conductive ink (209) across the surround, thus connecting the voice coil to the driver electronics.

### CROSS-REFERENCE TO RELATED APPLICATION

This application claims the benefit of U.S. Provisional Application No. 61/487,277, filed May 18, 2011, incorporated herein by reference in its entirety.

### FIELD OF THE DISCLOSURE

The present disclosure relates generally to synthetic jet ejectors, and more particularly to systems and methods for integrating components into synthetic jet ejectors.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows“; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System“; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing“; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices“; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIG. 1 is an illustration depicting the manner in which a synthetic jet actuator operates.

FIG. 2 is an illustration of a moving coil synthetic jet actuator which includes an inkjet printed interconnect.

FIG. 3 is an illustration of a synthetic jet actuator which utilizes a method for routing tinsel leads to avoid contact with the surround.

FIG. 4 is an illustration of a synthetic jet actuator which utilizes a method for routing tinsel leads to avoid contact with the surround.

FIG. 5 is a side view, partially in section, which illustrates a voice coil equipped with through-motor voice coil leads.

FIG. 6 is a top view of the voice coil of FIG. 5.

FIG. 7 is a top view of a synthetic jet actuator which utilizes tinsel routing scheme that avoids contact with the surround.

FIG. 8 is a top view of a synthetic jet actuator having a conventional tinsel deployment.

FIG. 9 is a cross-sectional view of the synthetic jet actuator of FIG. 8.

FIG. 10 is a top view of a synthetic jet actuator having a tinsel deployment in accordance with the teachings herein.

FIG. 11 is a cross-sectional view of the synthetic jet actuator of FIG. 10.

FIG. 12 is a cross-sectional view showing a tinsel-free synthetic jet actuator in accordance with the teachings herein.

FIG. 13 is a top view of the synthetic jet actuator of FIG. 12.

FIGS. 14-16 are illustrations of tinsel-free synthetic jet actuators in accordance with the teachings herein which have patterned metal diaphragm interconnects.

FIG. 17 is a top view of an synthetic jet actuator in accordance with the teachings herein which utilizes a spiral tinsel routing design.

### SUMMARY OF THE DISCLOSURE

In one aspect, a method is provided for forming tinsel on a synthetic jet actuator. The method comprises (a) providing a synthetic jet actuator assembly comprising a coil, driver electronics, and a surround; and (b) completing an electrical circuit between the coil and the driver electronics by depositing a conductive ink across the surround.

In another aspect, a synthetic jet actuator is provided which comprises (a) a coil, driver electronics, and a surround; and (b) a conductive ink which extends across the surround and which forms an electrical circuit between the coil and the driver electronics.

In a further aspect, a synthetic jet actuator is provided which comprises (a) a diaphragm equipped with a surround; (b) a voice coil having first and second terminal portions; (c) a pot structure having first and second portions which are electrically isolated from each other; (d) a first portion of tinsel having a first end which is in electrical communication with said first terminal portion of said voice coil, and a second end which is in electrical communication with said first portion of said pot structure; and (e) a second portion of tinsel having a first end which is in electrical communication with said second terminal portion of said voice coil, and a second end which is in electrical communication with said second portion of said pot structure.

In still another aspect, a synthetic jet actuator is provided which comprises (a) a diaphragm equipped with a surround; (b) a voice coil having first and second terminal portions; (c) a pot structure having first and second passageways defined therein; (d) a first portion of tinsel which extends through said first passage way and which is in electrical communication with said first terminal portion of said voice coil; and (e) a second portion of tinsel which extends through said second passage way and which is in electrical communication with said second terminal portion of said voice coil.

In another aspect, a synthetic jet actuator is provided which comprises (a) a diaphragm equipped with a surround; (b) a voice coil having first and second terminal portions; (c) a pot structure having first and second passageways defined therein; (d) a first conductive element which extends through said first passage way and which is in electrical communication with said first terminal portion of said voice coil; and (e) a second portion of tinsel which extends through said second passage way and which is in electrical communication with said second terminal portion of said voice coil.

In a further aspect, a synthetic jet actuator is provided which comprises (a) a diaphragm equipped with a surround; and (b) a plurality of electrically conductive elements integrated with said surround.

### DETAILED DESCRIPTION

The devices and methodologies disclosed herein utilize synthetic jet actuators or synthetic jet ejectors. Prior to describing these devices and methodologies, a brief explanation of a typical synthetic jet ejector, and the manner in which it operates to create a synthetic jet, may be useful.

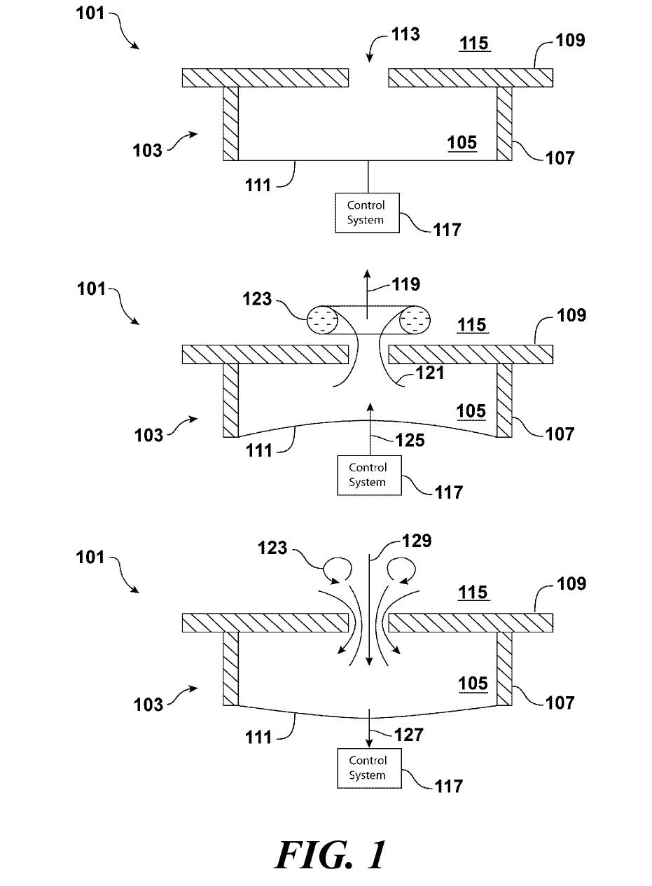

The formation of a synthetic jet may be appreciated with respect to FIGS. 1-3. FIG. 1 depicts a synthetic jet ejector 101 comprising a housing 103 which defines and encloses an internal chamber 105. The housing 103 and chamber 105 may take virtually any geometric configuration, but for purposes of discussion and understanding, the housing 103 is shown in cross-section in FIG. 1 to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein (see FIG. 1) which may be of various geometric shapes. The orifice 113 diametrically opposes the rear diaphragm 111 and fluidically connects the internal chamber 105 to an external environment having ambient fluid 115.

The movement of the flexible diaphragm 111 may be controlled by any suitable control system 117. For example, the diaphragm may be moved by a voice coil actuator. The diaphragm 111 may also be equipped with a metal layer, and a metal electrode may be disposed adjacent to, but spaced from, the metal layer so that the diaphragm 111 can be moved via an electrical bias imposed between the electrode and the metal layer. Moreover, the generation of the electrical bias can be controlled by any suitable device, for example but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

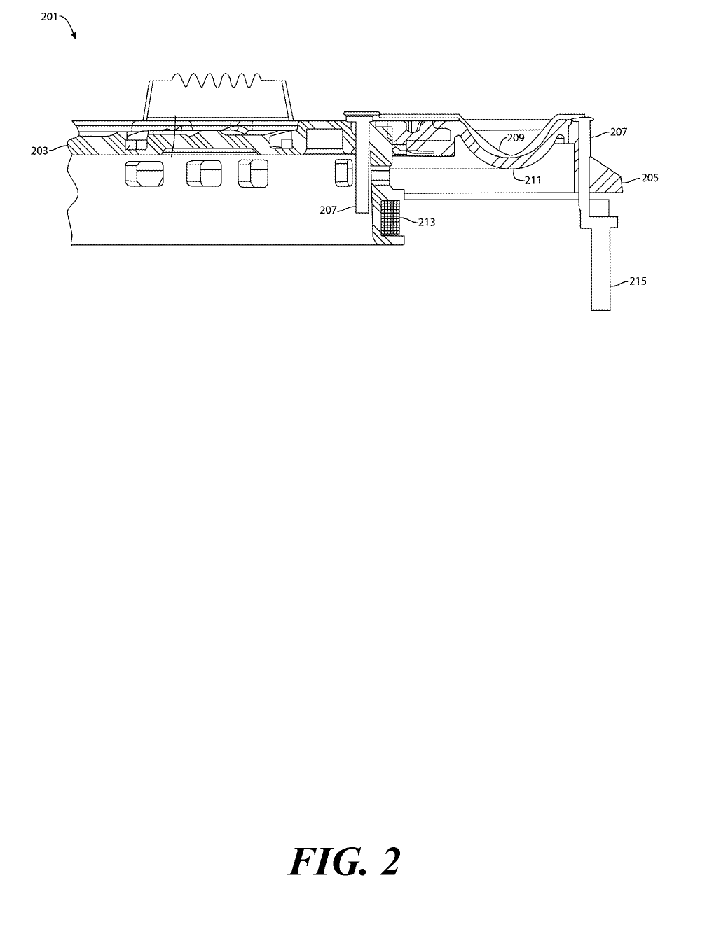

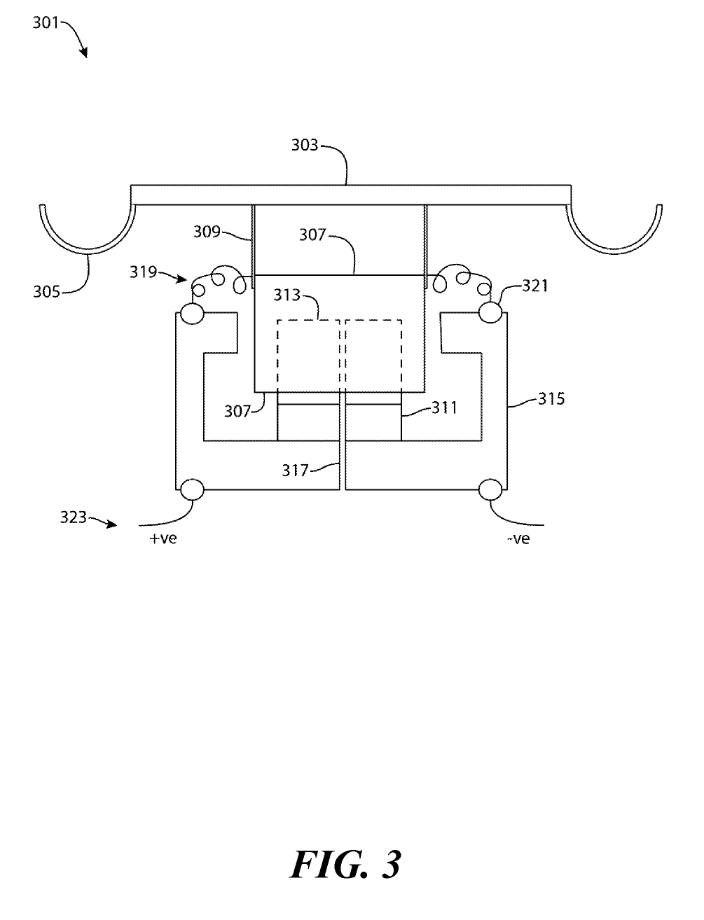

The operation of the synthetic jet ejector 101 will now be described with reference to FIGS. 2-3. FIG. 2 depicts the synthetic jet ejector 101 as the diaphragm 111 is controlled to move inward into the chamber 105, as depicted by arrow 125. The chamber 105 has its volume decreased and fluid is ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 3 depicts the synthetic jet ejector 101 as the diaphragm 111 is controlled to move outward with respect to the chamber 105, as depicted by arrow 127. The chamber 105 has its volume increased and ambient fluid 115 rushes into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

The devices and methodologies described above represent notable improvements in synthetic jet technology. However, a number of problems still exist in the art. In particular, many synthetic jet ejectors require the use of tinsel wires or flexible circuit connections between the coil terminals of a moving synthetic jet actuator. These types of connections are prone to breaking or wear, present manufacturing difficulties, and also create surfaces that other components may become caught on or entangled with.

It has now been found that some of the foregoing problems may be overcome through embodiments described herein which avoid the need for tinsel wires or a flexible circuit connection between the coil terminals of a moving coil actuator. This may be accomplished, for example, by utilizing Polymer Thick Film (PTF) conductive inks that may be printed on three-dimensional surfaces using inkjet deposition technologies.

It has further been found that some of the foregoing problems may be overcome by soldering the tinsel leads coming from the diaphragm to the pot magnet structure. The pot magnet structure is preferably in two semicircular halves that do not have electrical contact with each other, thus eliminating contact with the surround.

It has also been found that some of the foregoing problems may be overcome by routing tinsel leads coming from the diaphragm through via holes in the pot structure or frame before reaching the diametric location of the surround, or by using other tinsel routing methodologies as described herein.

FIG. 2 shows a particular, non-limiting embodiment of a printed interconnect for moving actuators in accordance with the teachings herein. As seen therein, a moving coil synthetic jet actuator 201 is provided which comprises a plastic bobbin 203 and actuator basket 205. A pair of terminal pins 207 are inserted into the bobbin 203 and actuator basket 205, and a printed interconnect 209 is provided which extends between the terminal pin in the actuator basket 205 to the terminal pin in the bobbin 203.

Various printable conductive inks may be utilized to form the printed interconnect 209. Preferably, the printable conductive ink is a polymer thick film (PTF) based ink, though conductive inks based on fired high solids compositions or nanoparticles may also be utilized. These inks allow circuits to be drawn or printed on a variety of substrate materials, including polyester or paper, and may contain conductive ingredients or fillers such as powdered or flaked silver, carbon or graphite. These inks may be deposited using inkjet material deposition techniques, which may utilize a print head equipped with piezoelectric crystals.

By utilizing terminal pins 207 inserted into the plastic bobbin 203 and actuator basket 205, the PTF conductive ink 209 can be printed in a trace or plane shape that extends across the roll of the surround 211 and connects the voice coil 213 to the driver board electronics 215. This conductive ink 209 may be bonded to the surround 211 of the actuator 201, thus ensuring that the electrical connection travels in unison with the surround 211 and cannot contact any other parts to cause acoustic artifacts.

The surround 211 can be shaped to minimize bending in any region and to provide high reliability in a dynamic flex environment. Since the surface where the printing of the conductive ink 209 is deposited is on the outside of the synthetic jet actuator 201, this step may be performed after the complete synthetic jet actuator assembly is assembled and (if applicable) ultrasonically welded together. This method is also compatible with automated assembly techniques, since it does not require a tinsel wire or flexible circuit to be carefully woven through the support structure of the synthetic jet actuator.

FIG. 3 depicts a particular, non-limiting embodiment of a device and methodology for routing tinsel leads in accordance herein, and which avoids contact with the surround. In the embodiment depicted therein, a synthetic jet actuator 301 is provided which comprises a diaphragm 303 equipped with a surround 305, a voice coil 307 disposed around a coil former (not shown), a suspension 309, a magnet 311, a top plate 313, and a pot 315. The pot 315, magnet 311 and top plate 313 are split into opposing semicircular halves that are electrically isolated from each other. This may be achieved by the provision of a gap 317 or by the disposition of a dielectric material disposed between the semicircular halves.

First and second portions of tinsel 319 are arranged such that one end of each portion of tinsel 319 is attached to one of the semicircular halves of the pot 315 by way of a solder joint 321, and the other end of each portion of tinsel 319 is attached to a lead on the coil 307. Positive and negative electrical leads 323 are attached to one of the semicircular halves of the pot 315 by way of a solder joint 321. This arrangement eliminates any contact between the tinsel 319 and the surround 305.

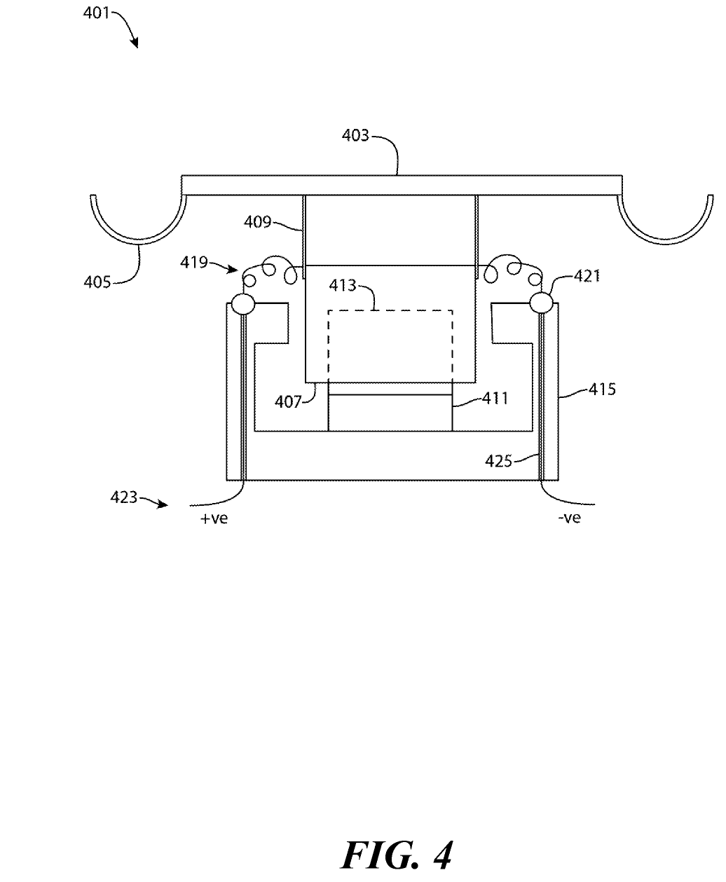

FIG. 4 depicts another particular embodiment of a device and method for routing tinsel leads in accordance with the teachings herein which avoid contact with the surround. In the embodiment depicted therein, a synthetic jet actuator 401 is provided which comprises a diaphragm 403 equipped with a surround 405, a voice coil 407 on a coil former, a magnet 411, a top plate 413, and a pot 415. First and second portions of tinsel 419 or wire are routed through passageways 425 provided in the structure of the pot 415, and are held in place by a portion of glue 421 applied to one end of the passageways 425. The tinsel 419 or wires may then be attached to the drive electronics through a bar acting as a single leaf spring, by a helical spring, or by other means.

The passageways 425 are preferably large enough to provide clearance so that the tinsel 419 or wires do not come into contact with the moving parts of the synthetic jet actuator 401. Also, it is preferable that the travel path of the diaphragm 403 be uniform (normal to the voice coil 407). This wire routing method will help improve reliability as well as acoustics due to tinsel noise. As with the previous embodiment, this arrangement may be used to eliminate any contact between the tinsel 419 and the surround 405.

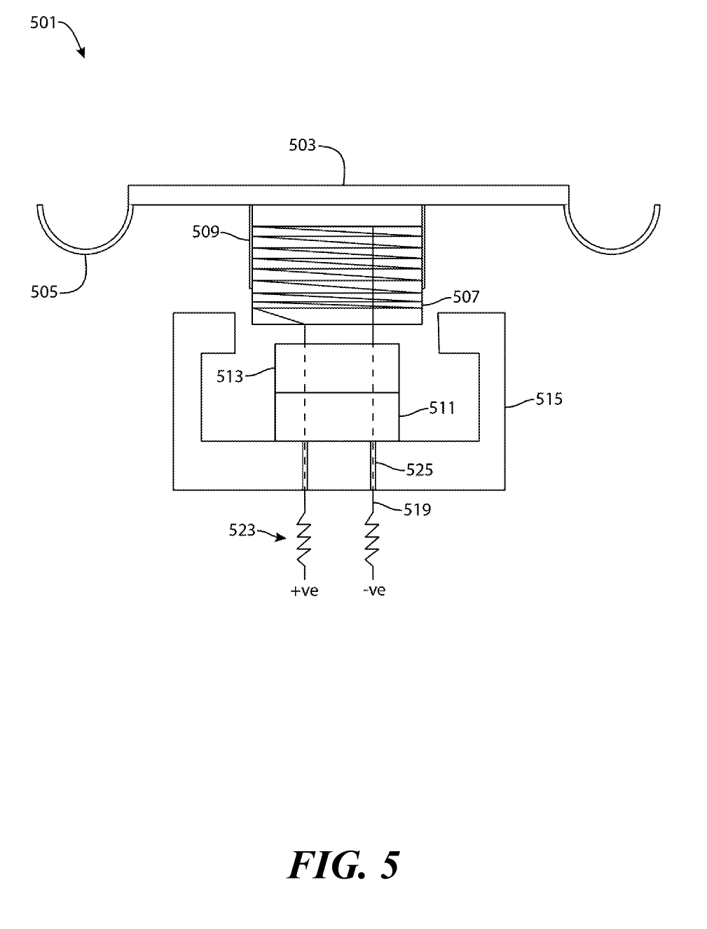

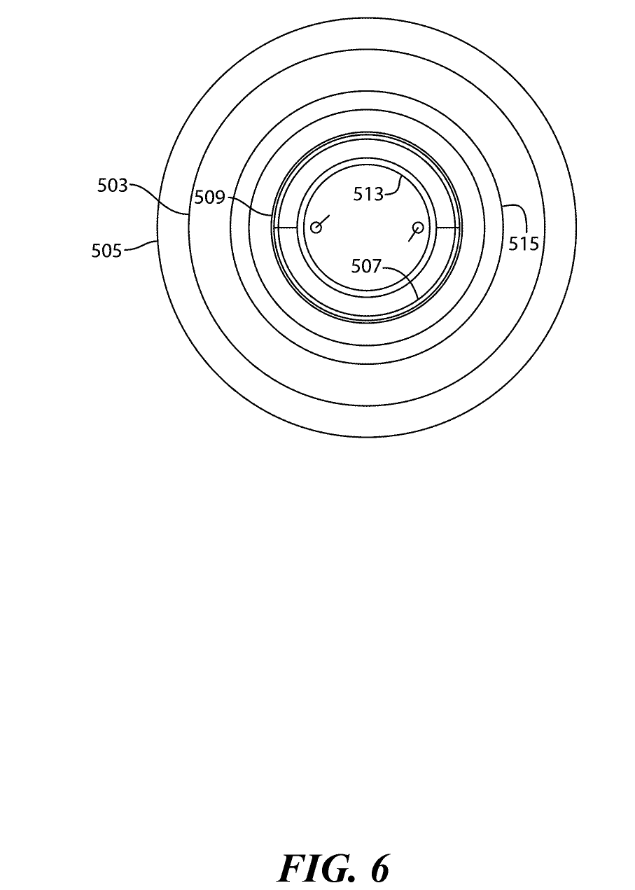

FIGS. 5-6 depict another particular embodiment of a device and methodology in accordance herein which avoids contact between tinsel and the surround. In the embodiment depicted therein, a synthetic jet actuator 501 is provided which comprises a diaphragm 503 equipped with a surround 505, a coil 507 on a coil former, a suspension 509, a magnet 511, a top plate 513, and a pot 515. First and second portions of wire 519, which may be the same wire used to form the voice coil or may be separate (possibly thicker and stiffer) wire leads, are routed through passageways 525 provided in the structure of the pot 515. Each of the first and second portions of wire 519 may be attached to a spring 523 on the other end of the passageways 525. As with the previous embodiment, this arrangement may be utilized to eliminate any contact that might otherwise occur between the tinsel and the surround 505.

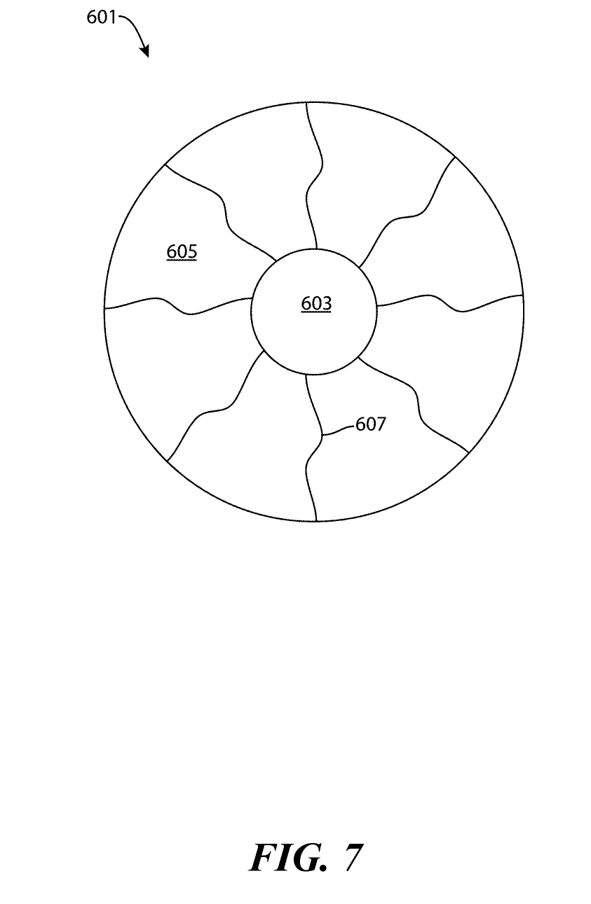

FIG. 7 depicts a further particular embodiment of a device and methodology in accordance with the teachings herein which avoids contact between tinsel and the surround. In the embodiment depicted therein, a synthetic jet actuator 601 is provided which comprises a voice coil 603 disposed on a coil former (not shown) and a surround 605. A plurality of tinsel leads 607 are woven into the material of the surround 605. The tinsel leads 607 preferably extend in a non-linear (e.g., curved, tortuous or sinusoidal) path across the surround.

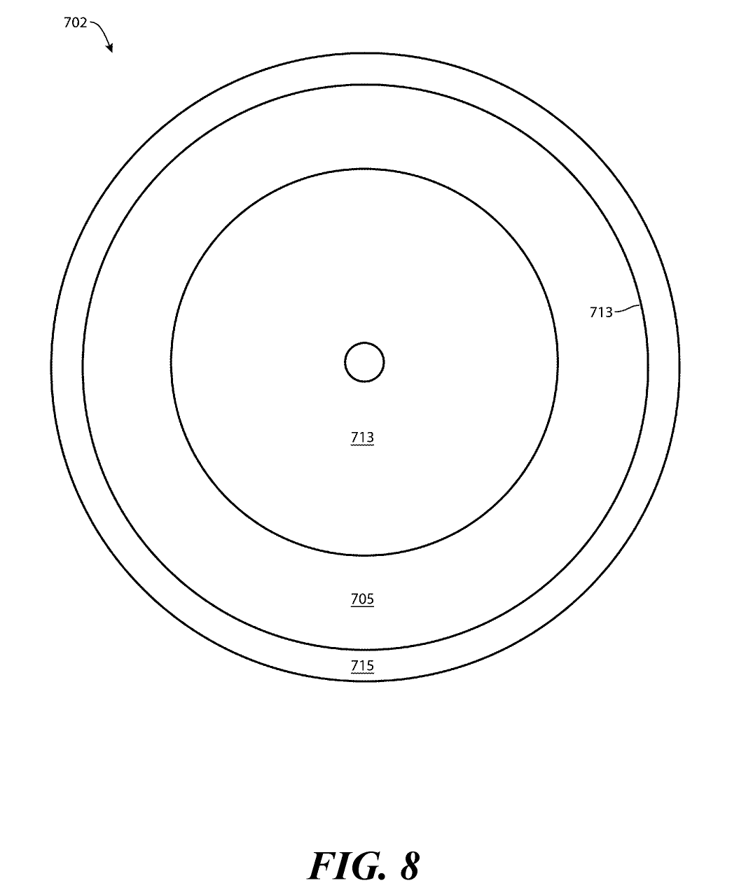

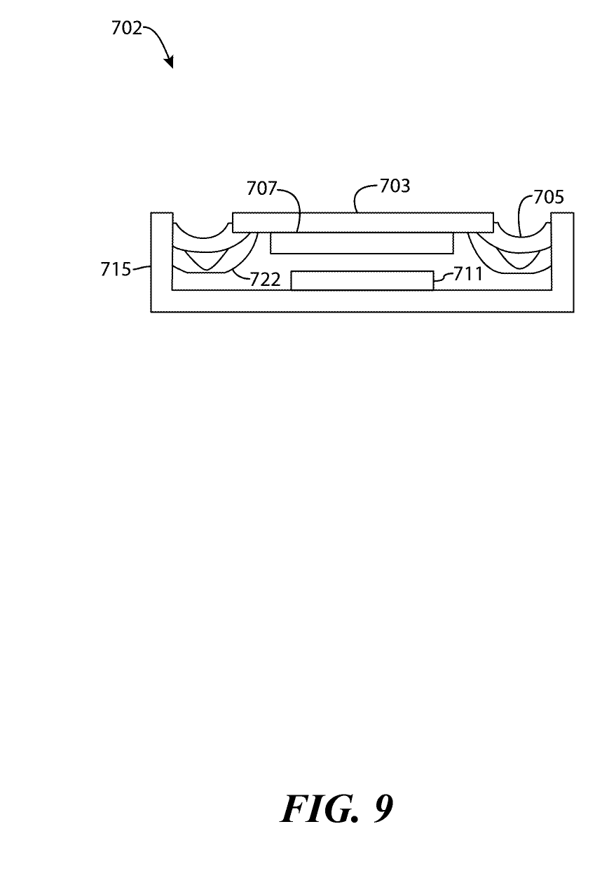

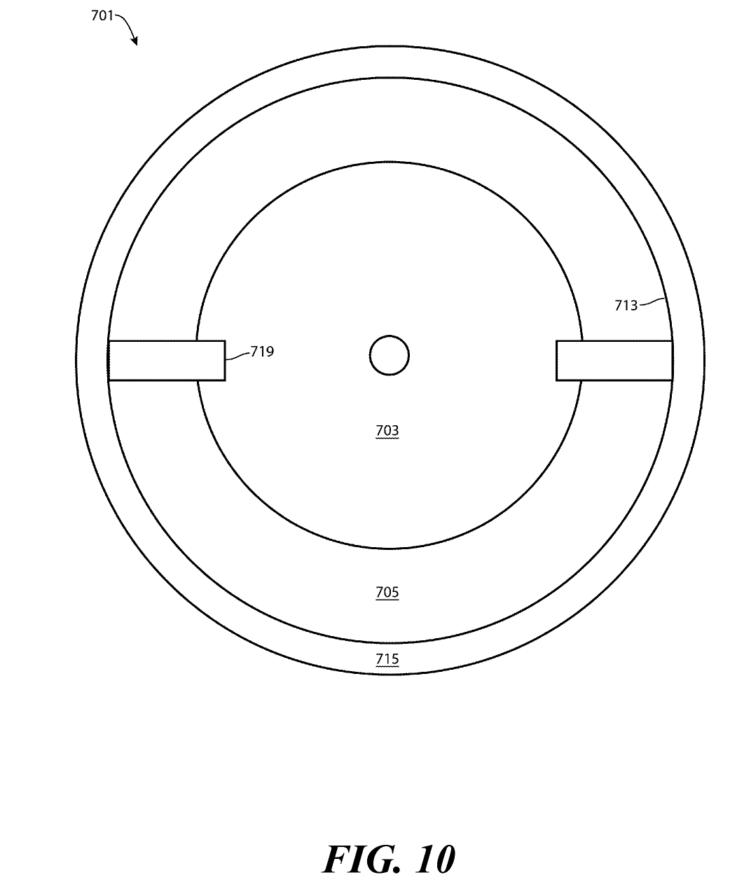

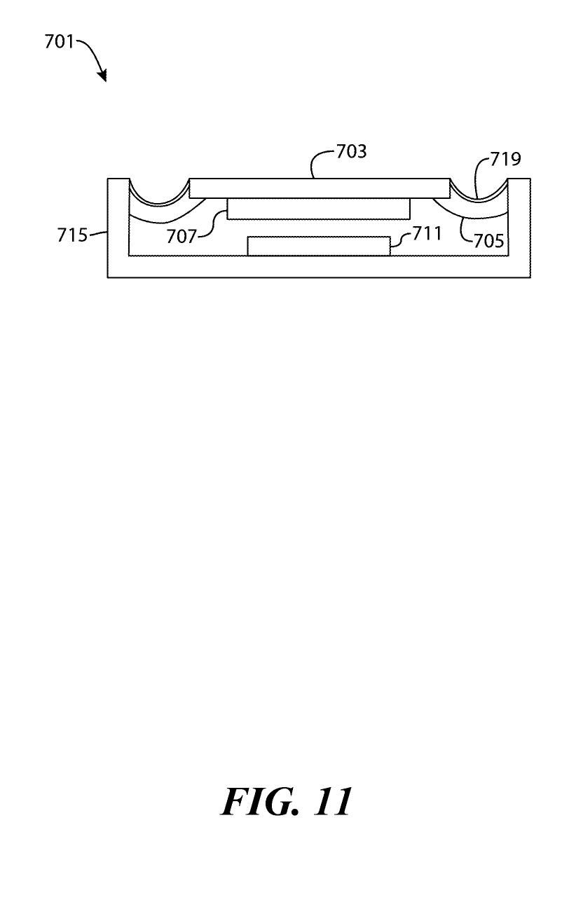

FIGS. 10-11 depict another particular, non-limiting embodiment of a synthetic jet actuator in accordance with the teachings herein. The actuator 701 depicted therein comprises a diaphragm 703 equipped with a surround 705, a coil 707 (see FIG. 11) on a coil former (not shown), a magnet 711 and a basket 715. The actuator 701 incorporates a tinsel-less design that utilizes a carbon nanotube coating 719 on the diaphragm 703 to form a conductive, elastomeric diaphragm 703. The corresponding conventional actuator 702 (without a carbon nanotube coating 719) is shown in FIGS. 8-9.

In a preferred embodiment of this approach, the carbon nanotube coating 719 on the actuator diaphragm 703 is a thin, preferably elastomeric layer that connects the center of the actuator 701 to the edge of the basket 715 along the surface of the diaphragm 703. This provides an electrical connection between the voice coil 707 and a power source, without interfering with the internal geometry or volume of the synthetic jet actuator 701. By contrast, the corresponding conventional synthetic jet actuator 702 depicted in FIGS. 10-11 uses tinsels or flexible circuits 722 to connect the voice coil 707 to the power source. Such use of tinsels or flexible circuits 722 occupies part of the internal volume of the synthetic jet actuator 701, and may present design issues with respect to the internal geometry. By contrast, as noted above, the actuator 701 of FIGS. 10-11 uses a carbon nanotube coating 719 to connect the coil 707 to the outside power source, thus leaving extra internal volume and allowing for more extensive design space.

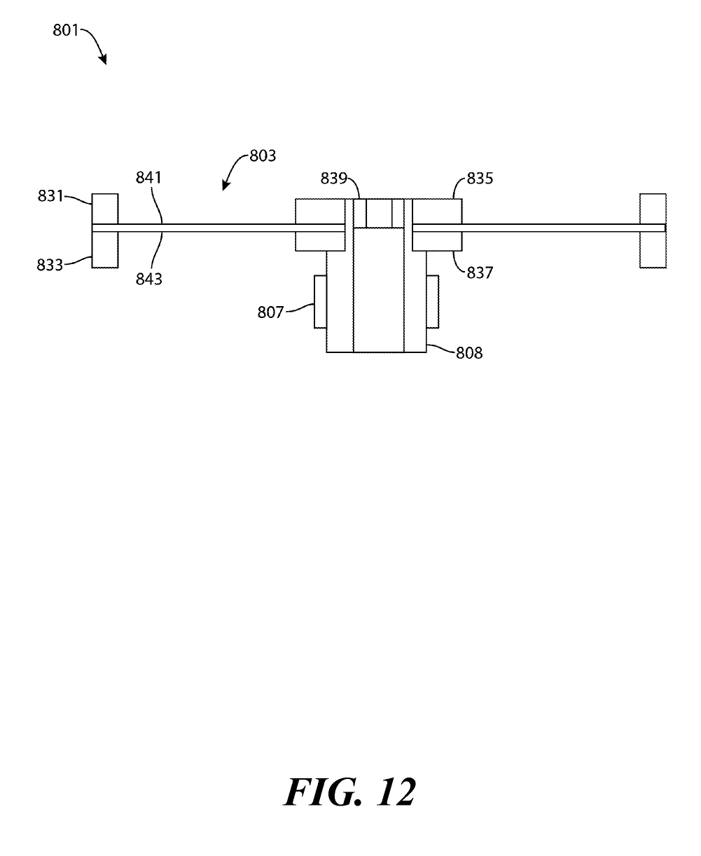

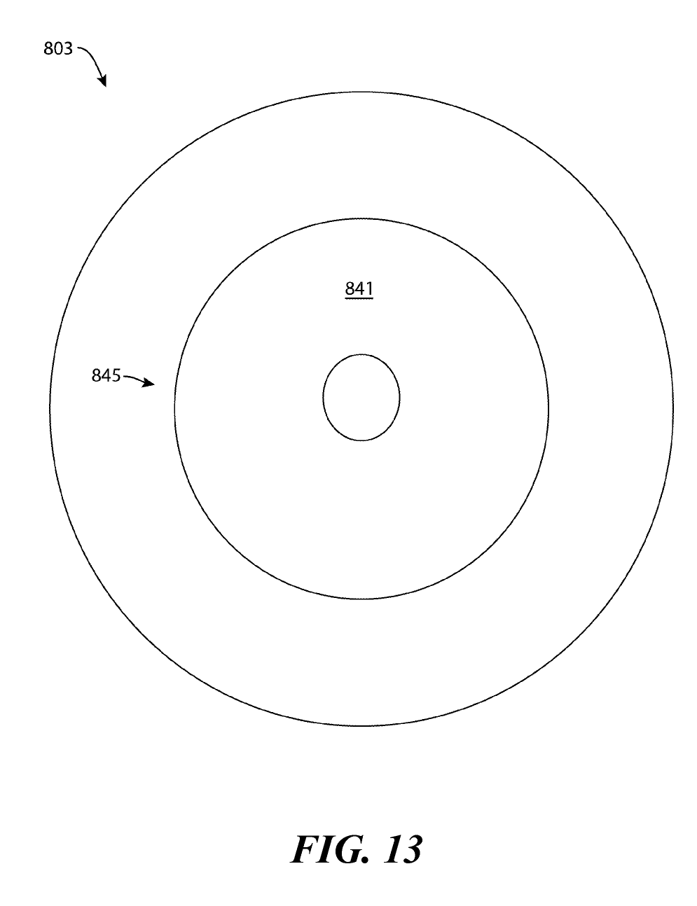

FIGS. 12-13 illustrate another particular, non-limiting embodiment of a synthetic jet actuator in accordance with the teachings herein which incorporates a tinsel-less design. The actuator 801 depicted therein comprises a diaphragm 803, a voice coil 807 on a coil former 808, an upper outer contact ring 831, a lower outer contact ring 833, an upper inner contact ring 835, a lower inner contact ring 837, and an inner sleeve 839. The diaphragm 803 has opposing upper 841 and lower 843 major surfaces which are electrically conductive. The diaphragm 803 preferably comprises a polymeric material and is preferably metalized on both sides. The inner sleeve 839 is equipped with metal splines 845 which allow the voice coil 807 to be in electrical contact with the upper surface 841 of the diaphragm 803. In addition, the coil former 808, which is preferably not electrically conductive, is equipped with 90° notches to permit the splines 845 in the inner sleeve 839 to press fit with the upper inner contact ring 835.

It will be appreciated that the synthetic jet actuator 801 of FIGS. 12-13 employs a conductive diaphragm 803 that replaces the tinsel connections normally used to make electrical connection to the voice coil 807. The design employs crimp and press-fit fittings to permit automated assembly and long travel of the diaphragm 803 that is often limited by conventional tinsel connections.

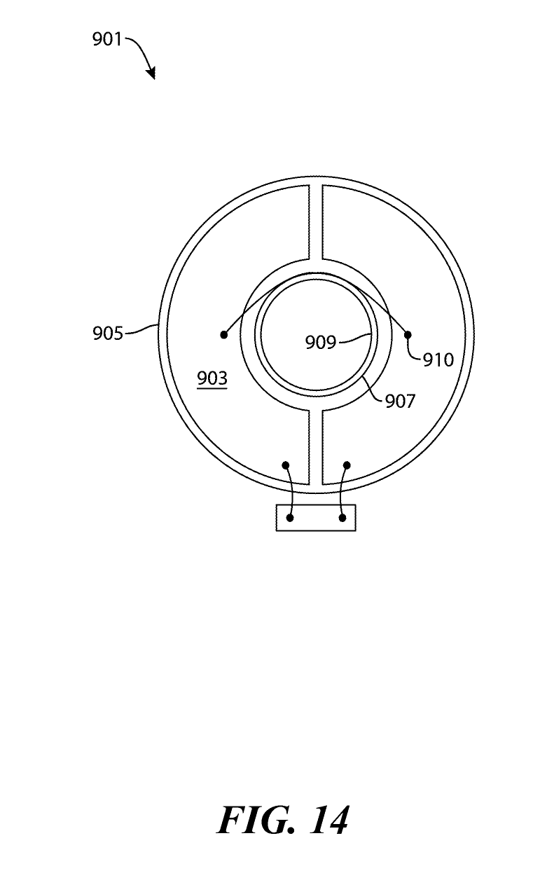

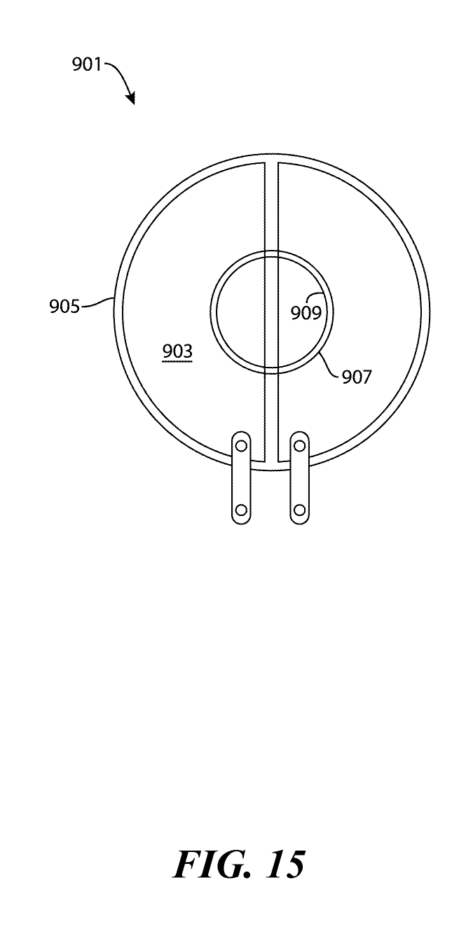

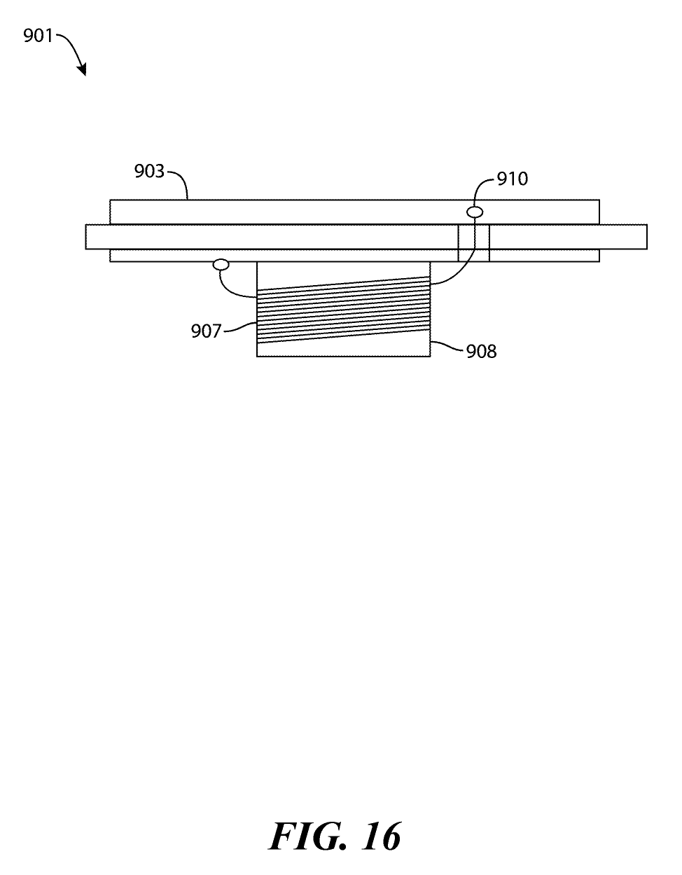

FIGS. 14-16 illustrate a particular, non-limiting embodiment of a tinsel-free synthetic jet actuator in accordance with the teachings herein which utilizes a patterned metal speaker interconnect. The synthetic jet actuator 901 depicted therein comprises a diaphragm 903 equipped with a surround 905, and a voice coil 907 on a coil former 909. The actuator 901 includes a patterned metal interconnect 910 for forming an electrical connection between the voice coil 907 and the diaphragm 903.

The diaphragm 903 and surround material 905 are coated (e.g., through vapor deposition, sputtering, plating, or otherwise depositing metal or other conductive materials) with a patterned conductive structure to provide a current path to and from the wires of the voice coil 907. Preferably, electrical connections are made to the metallic coating through the use of a suitable adhesive, by soldering, or the like. The metal coating may be implemented in various shapes and patterns as necessary to achieve the desired electrical and mechanical properties and a suitable lifetime. The electrical contact may be made by pressing, press fitting, crimping, clamping, or through the use of other suitable means.

In a preferred embodiment, an insulating diaphragm 903 is utilized which is coated on one, and preferably on both, sides to provide a current path to and from the voice coil 907. The connection may be made by crimping the top and bottom of the diaphragm 903 to the voice coil former 909. In some embodiments, the entire diaphragm 903 may be made of a material that can be doped, irradiated or otherwise treated so as to change its properties from conductive to non-conductive (or from non-conductive to conductive) to provide two distinct current paths to the voice coil 907.

The foregoing methods may also be combined with other methods, such as the use of tinsel wires, to achieve desired electrical and mechanical properties and a suitable lifetime. Moreover, to aid in current routing, the voice coil 907 may be coated or patterned using methodologies such as those described above.

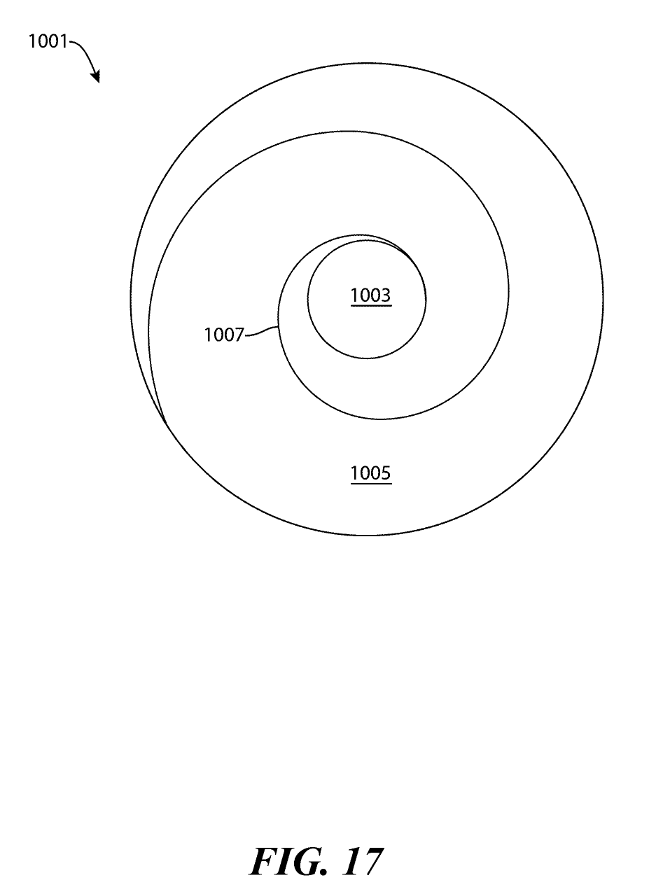

FIG. 17 illustrates another particular, non-limiting embodiment of a synthetic jet actuator in accordance with the teachings herein. The actuator 1001 depicted therein comprises a voice coil 1003, a diaphragm 1005, and one or more portions of tinsel 1007 which extend from the voice coil 1003 to the edge of the diaphragm 1005. The synthetic jet actuator 1001 depicted utilizes a spiral routing scheme for the tinsel 1007 so as to minimize flexing and improve reliability.

It is typically necessary to connect the moving voice coil of a synthetic jet actuator to a fixed point for external electrical power to drive the coil. The wires used for this connection are specially designed for long flexure life. The synthetic jet actuator 1001 of FIG. 17 is advantageous in that the tinsel 1007 or wires utilized for this connection minimize flex stress concentration, such as at the termination points, thus helping to improve reliability. In particular, by using the tinsel routing scheme described herein, the flexing is distributed along an extended length and minimizes the flexure of any point along the tinsel 1007. This approach also helps to prevent resonant looping motion.

The diaphragm 1005, which is driven by the motion of the voice coil 1003, often is made with reinforcing ribs or rings molded into it to give more uniform motion, to prevent buckling, and to add strength. By molding the rings as spirals from the coil connection points near the center to the outer rim of the diaphragm 1005, the strength benefits can be obtained. Moreover, by routing the tinsel 1007 along the spirals (e.g., next to the ridge of the spirals or between these ridges), the tinsel 1007 is flexed only a very small amount, and uniformly along the entire path from the voice coil 1003 to the fixed termination point. Hence, instead of having the end-to-end displacement of the tinsel 1007 occur over approximately one radial length, it can occur over 2π× the radial length or longer if the spiral makes several revolutions between the center and the outer perimeter of the diaphragm 1005.

Several variations are possible with the foregoing embodiment. Typically, at least two tinsels will be required to connect the voice coil to an external power source. In some embodiments, a single spiral may be provided in the diaphragm with both tinsels run adjacent to each other, and with the tinsels electrically insulated from each other. In other embodiments, a separate spiral may be provided for each tinsel. The tinsel may be disposed on the top or bottom surface of the diaphragm, or both. One or more tabs may be provided on the rim of the diaphragm to make electrical connections to the tinsel.

In some embodiments of the devices and methodologies described herein, the voice coils utilized may be powered through electrical induction. In accordance with such methods, electrical power is delivered to the voice coil without tinsels (e.g., wirelessly) by using an electric inductance effect. An external coil is used to emit the AC magnetic field, which in turn is picked up by the voice coil or a secondary pick up coil to power the voice coil.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for forming tinsel on a synthetic jet actuator, comprising:
providing a synthetic jet actuator assembly comprising a coil, driver electronics, and a surround; and
completing an electrical circuit between the coil and the driver electronics by depositing a conductive ink across the surround.

2. The method of claim 1, wherein the conductive ink is a polymer thick film (PTF) conductive ink.

3. The method of claim 1, wherein the conductive ink comprises a fired high solids composition.

4. The method of claim 1, wherein the conductive ink comprises nanoparticles.

5. The method of claim 1, wherein the conductive ink comprises carbon nanotubes.

6. The method of claim 1, wherein depositing a conductive ink across the surround is accomplished with inkjet material deposition.

7. The method of claim 6, wherein the conductive ink is deposited using a printhead equipped with piezoelectric crystals.

8. The method of claim 1, wherein the synthetic jet actuator further comprises a first terminal which is in electrical contact with said coil, and a second terminal which is in electrical contact with said driver electronics.

9. The method of claim 8, wherein said coil is disposed on a bobbin, and wherein said first terminal is a pin inserted into said bobbin.

10. The method of claim 9, wherein the bobbin comprises a plastic.

11. The method of claim 1, wherein the synthetic jet actuator assembly further comprises an actuator basket, and wherein said second terminal is a pin inserted into the actuator basket.

12. A synthetic jet actuator, comprising:
a coil;
driver electronics;
a surround; and
a conductive ink which extends across the surround and which forms an electrical circuit between the coil and the driver electronics.

13. The synthetic jet ejector of claim 12, wherein said conductive ink is disposed on the surface of the surround.

14. The synthetic jet ejector of claim 1, wherein the conductive ink is a polymer thick film (PTF) conductive ink.

15. The synthetic jet ejector of claim 1, wherein the conductive ink comprises a fired high solids composition.

16. The synthetic jet ejector of claim 12, wherein the synthetic jet actuator further comprises a first terminal which is in electrical contact with said coil, and a second terminal which is in electrical contact with said driver electronics.

17. The synthetic jet ejector of claim 16, wherein said coil is disposed on a bobbin, and wherein said first terminal is a pin inserted into said bobbin.

18. The synthetic jet ejector of claim 17, wherein the bobbin comprises a plastic.

19. The synthetic jet ejector of claim 12, wherein the synthetic jet actuator assembly further comprises an actuator basket, and wherein said second terminal is a pin inserted into the actuator basket.

20. A synthetic jet actuator, comprising:
a diaphragm equipped with a surround;
a voice coil having first and second terminal portions;
a pot structure having first and second portions which are electrically isolated from each other;
a first portion of tinsel having a first end which is in electrical communication with said first terminal portion of said voice coil, and a second end which is in electrical communication with said first portion of said pot structure; and
a second portion of tinsel having a first end which is in electrical communication with said second terminal portion of said voice coil, and a second end which is in electrical communication with said second portion of said pot structure.

21. The synthetic jet actuator of claim 20, wherein said first and second portions of said pot structure are spaced apart from each other.

22. The synthetic jet actuator of claim 20, wherein said first and second portions of said pot structure have a dielectric material disposed between them.

23. The synthetic jet actuator of claim 20, further comprising a magnet having first and second portions which are electrically isolated from each other.

24. The synthetic jet actuator of claim 23, wherein said first and second portions of said magnet are spaced apart from each other.

25. The synthetic jet actuator of claim 23, wherein said first and second portions of said magnet have a dielectric material disposed between them.

26. The synthetic jet actuator of claim 23, wherein said magnet is disposed on, and in contact with, said pot structure.

27. The synthetic jet actuator of claim 23, further comprising a top plate disposed on said magnet, said top plate having first and second portions which are electrically isolated from each other.

28. The synthetic jet actuator of claim 27, wherein said first and second portions of said magnet are spaced apart from each other.

29. The synthetic jet actuator of claim 27, wherein said first and second portions of said magnet have a dielectric material disposed between them.

30. The synthetic jet actuator of claim 20, wherein said voice coil and said pot structure are spaced apart from said diaphragm.

31. The synthetic jet actuator of claim 20, wherein said pot structure is annular in shape.

32. A synthetic jet actuator, comprising:
a diaphragm equipped with a surround;
a voice coil having first and second terminal portions;
a pot structure having first and second passageways defined therein;
a first conductive element which extends through said first passage way and which is in electrical communication with said first terminal portion of said voice coil; and
a second portion of tinsel which extends through said second passage way and which is in electrical communication with said second terminal portion of said voice coil.

33. The synthetic jet actuator of claim 32, wherein said voice coil and said pot structure are spaced apart from said diaphragm.

34. The synthetic jet actuator of claim 32, wherein said pot structure is annular in shape.

35. The synthetic jet actuator of claim 32, wherein at least one of said first and second conductive elements is a portion of tinsel.

36. The synthetic jet actuator of claim 32, wherein each of said first and second conductive elements is a portion of tinsel.

37. The synthetic jet actuator of claim 32, wherein said voice coil comprises a first wire, and wherein at least one of said first and second conductive elements comprises said first wire.

38. The synthetic jet actuator of claim 32, wherein said voice coil comprises a first wire, and wherein both of said first and second conductive elements comprises said first wire.

39. The synthetic jet actuator of claim 32, wherein said voice coil comprises a first wire, and wherein at least one of said first and second conductive elements comprises a second wire of larger caliper than said first wire.

40. The synthetic jet actuator of claim 32, wherein said voice coil comprises a first wire, and wherein each of said first and second conductive elements comprises a second wire of larger caliper than said first wire.

41. A synthetic jet actuator, comprising:
a diaphragm equipped with a surround; and
a plurality of electrically conductive elements integrated with said surround.

42. The synthetic jet actuator of claim 41, wherein said conductive elements comprise tinsel leads embedded in said surround.

43. The synthetic jet actuator of claim 42, wherein each of said tinsel leads extends in a non-linear manner across said surround.

44. The synthetic jet actuator of claim 42, wherein each of said tinsel leads extends in a tortuous path across said surround.

45. The synthetic jet actuator of claim 42, wherein each of said tinsel leads extends in a sinusoidal path across said surround.

46. The synthetic jet actuator of claim 41, wherein said conductive elements comprise tinsel leads disposed on the surface of said surround.

47. The synthetic jet actuator of claim 41, wherein said conductive elements comprise a conductive nanoparticle composition.

48. The synthetic jet actuator of claim 47, wherein said conductive nanoparticle composition is disposed on the surface of said surround.

49. The synthetic jet actuator of claim 47, wherein said conductive nanoparticle composition comprises carbon nanotubes.

50. The synthetic jet actuator of claim 41, further comprising:
a voice coil having first and second terminal portions which are in electrical communication with said conductive elements.

51. The synthetic jet actuator of claim 50, further comprising:
a pot structure having first and second passageways defined therein.
